(19) United States
(12) Patent Application Publication
(10) Pub. No.: US 2023/0036204 A1
(43) Pub. Date: Feb. 2, 2023

(54) Gaming Device

(71) Applicant: Peratech Holdco Limited, North Yorkshire (GB)

(72) Inventor: Fawad Ahmad, Uppsala (SE)

(21) Appl. No.: 17/952,269

(22) Filed: Sep. 25, 2022

Related U.S. Application Data
(63) Continuation of application No. PCT/GB2021/000031, filed on Mar. 25, 2021.

(30) Foreign Application Priority Data
Mar. 26, 2020 (GB) 2005910.1

(51) Int. Cl. A63F 13/2145; A63F 13/218

(52) U.S. Cl. CPC A63F 13/2145; A63F 13/218; A63F 2300/1075; A63F 2300/1056

(57) ABSTRACT

A portable gaming device comprises an electronic device comprising a processor configured to run application software. The gaming device also comprises a cover which is storeable in combination with the electronic device, and which is attachable and detachable from the electronic device. The cover comprises an input device comprising a touch sensitive device configured to measure a position and magnitude of an applied force. The touch sensitive device is also configured to provide an input signal to the application software in response to such an applied force.

### CROSS REFERENCE TO RELATED APPLICATIONS

This application is a continuation of International Patent Application PCT/GB2021/000031, filed on 25 Mar. 2021, which claims priority from United Kingdom Patent Application number GB 20 05 910.1, filed on 26 Mar. 2020. The whole contents of International Patent Application PCT/GB2021/000031 and United Kingdom Patent Application number GB 20 05 910.1 are incorporated herein by reference.

### BACKGROUND OF THE INVENTION

The present invention relates to a portable gaming device and cover thereof.

Electronic devices including smartphones, tablets and other portable handheld computers are increasingly frequent in the modern world. Many users utilize these devices to play games, usually provided by electronic applications, known as apps, installed on the electronic device in question.

Unlike conventional gaming consoles or personal computers provided with peripheral controllers, however, these portable electronic devices are not provided with means to operate in line with conventional gaming consoles, and instead typically utilize inputs to control the game by means of the touch screen of the electronic device.

Devices mimicking conventional gaming consoles have been proposed, but these usually lack the typical functions of smartphones. Indeed, existing smartphones do not typically have the capacity to combine with suitable input devices, and, in cases where these exist, such devices tend to be bulky and cumbersome, and consequently difficult to transport. In addition, peripheral devices are provided with their own power source, which can add to the issue of weight and reduced portability.

The invention described herein aims to improve these problems while increasing the gaming experience of a user utilizing their smartphone or other similar electronic device, which is conventionally utilized for more than just gaming.

### BRIEF SUMMARY OF THE INVENTION

According to a first aspect of the present invention, there is provided a portable gaming device, comprising: an electronic device comprising a processor configured to run application software; and a cover configured to be storeable in combination with said electronic device, said cover being attachable and detachable from said electronic device; wherein said cover comprises an input device comprising a touch sensitive device configured to measure a position and magnitude of an applied force, and said touch sensitive device is further configured to provide an input signal to said application software in response to said applied force.

According to a second aspect of the present invention, there is provided a cover for use in gaming with an electronic device, said cover being storeable in combination with said electronic device and attachable and detachable to said electronic device, said cover comprising: an input device comprising a touch sensitive device configured to measure a position and magnitude of an applied force; wherein: said touch sensitive device is further configured to provide an input signal to application software of said electronic device in response to said applied force.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 shows a user utilizing a conventional mobile telephone or smartphone for use in a portable gaming device of the present invention;

FIG. 2 shows a cover of a portable gaming device in accordance with the present invention;

FIG. 3 shows a schematic representation of a touch sensitive device forming part of the cover of FIG. 2;

FIG. 4 shows a schematic diagram of a portable gaming device comprising an electronic device and a cover;

FIG. 5 shows a first embodiment for a cover for use with an electronic device to form a portable gaming device;

FIG. 6 shows an alternative embodiment for a cover in combination with an electronic device to form a portable gaming device;

FIG. 7 shows a further cover in combination with an electronic device to form a portable gaming device; and

FIG. 8 shows the embodiment of FIG. 7 where the cover provides protection of the electronic device and its touch screen.

### DETAILED DESCRIPTION OF EMBODIMENTS OF THE INVENTION

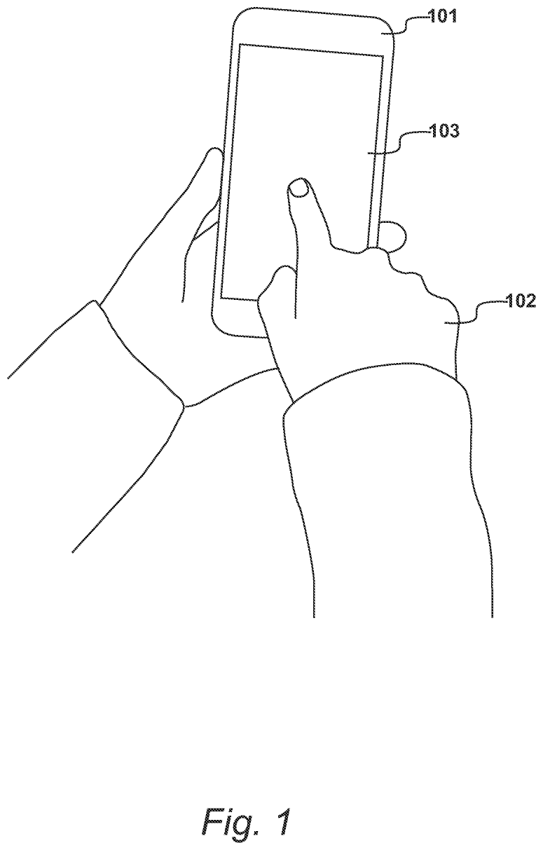

### FIG. 1

An electronic device 101 in the form of a mobile telephone is shown being utilized by a user 102. In the embodiment shown, user 102 may operate application software installed on electronic device 101 by means of an appropriate input device or input devices which form part of electronic device 101.

In the embodiment, electronic device 101 comprises a mobile telephone or smartphone. However, it is appreciated that, in alternative embodiments, electronic device 101 may be any suitable electronic device, preferably one having a degree of portability such as a handheld personal computer or tablet computer.

In the embodiment, electronic device 101 is provided with a touch screen 103 which user 102 applies a force, or finger press thereto to operate the device. Electronic device 101 may further comprise further input devices, such as buttons to operate electronic device 101.

When utilizing application software for gaming purposes, inputs are typically made in conventional smartphones by means of the touch screen 103. This provides a response which may, for example, move items on the screen, select items, activate items, or otherwise affect game play. However, in certain game play this can result in a less tactile or intuitive response compared to those provided by games consoles which typically comprise manual buttons. The portable gaming device of the present invention seeks to provide a cover in combination with an electronic device which addresses these problems.

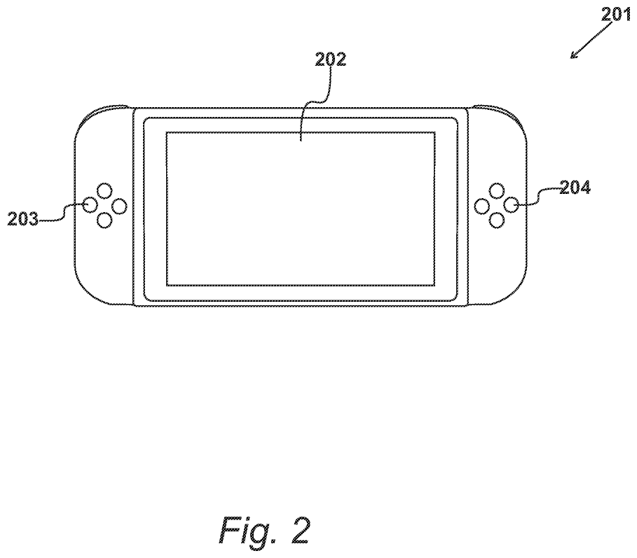

### FIG. 2

A portable gaming device in accordance with the invention comprises an electronic device, such as mobile telephone 101 and an apparatus in the form of a cover 201 as shown in FIG. 2.

Cover 201 provides an embodiment in accordance with the present invention in which cover 201 is configured to be attachable and detachable to an electronic device 101. The specification of the electronic device 101 is not paramount and it is appreciated that electronic device 101 may be a conventional smartphone running a conventional operating system such as Android® or Apple iOS® rather than a specified particular operating system. In FIG. 2, cover 201 is shown in isolation from electronic device 101.

In the embodiment, cover 201 comprises at least one input device. In the embodiment, cover 201 comprises an input device comprising a touch screen 202. Cover 201 further comprises a plurality of input devices 203 and 204 in the form of a plurality of analogue buttons. It is appreciated that any number of analogue buttons may be provided on cover 201 and may be arranged in any suitable arrangement or format. In this embodiment, the plurality of input devices 203 are four in number and are arranged in a pattern suitable for providing gaming inputs. Similarly, plurality of input devices 204 are also four in number and are arranged in a substantially similar pattern or arrangement.

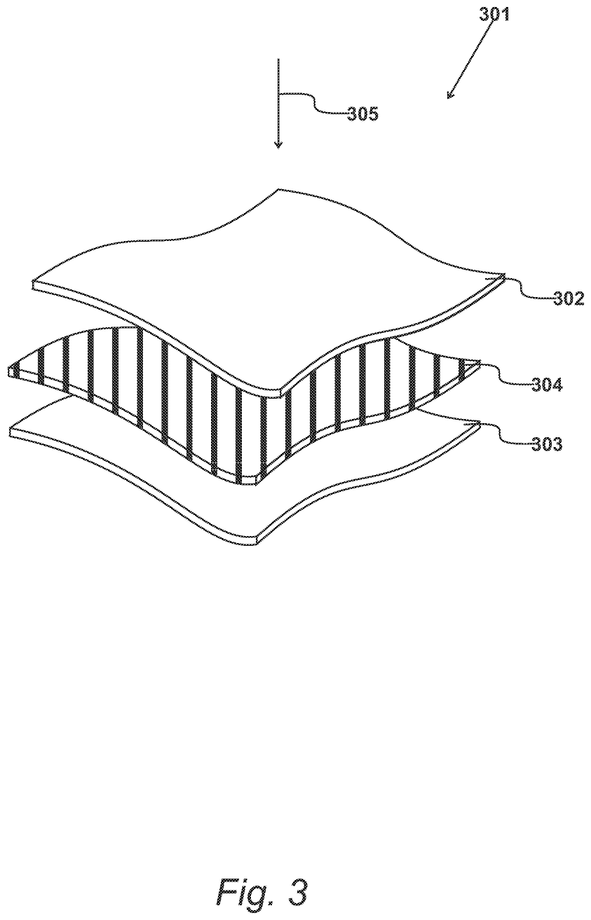

In the embodiment, the input device comprises a touch sensitive device. In the embodiment, the touch sensitive device forms part of touch screen 202. In an example embodiment, each of the plurality of analogue buttons are further provided with a touch sensitive device. An example touch sensitive device will be described with respect to FIG. 3.

By providing a detachable gaming-suitable cover of this type, both analogue inputs and touch sensitive capacity are provided to the electronic device to improve tactile feel during gaming even when utilizing a conventional smartphone. As the cover is configured to be detachable, the cover is flexible in use and a user can remove the cover if it is not required.

### FIG. 3

An example touch sensitive device which, in an embodiment, forms part of touch screen 202 and/or any one of the plurality of analogue buttons 203 or 204 is shown in schematic exploded form in FIG. 3.

Touch sensitive device 301 comprises a first conductive layer 302 and a second conductive layer 303. A pressure sensing layer 304 is positioned between conductive layer 302 and conductive layer 303.

In an embodiment, first conductive layer 302, second conductive layer 303 and pressure sensing layer 304 are sequentially printed as inks onto a substrate to form an appropriate touch sensing device 301.

In the embodiment, conductive layers 302 and 303 may comprise a carbon-based material and/or a silver-based material and pressure sensing layer 304 comprises a pressure sensitive material such as the type supplied by the applicant Peratech Holdco Limited under the trade mark QTC®. This pressure sensitive material comprises a quantum tunnelling composite material which is configured to exhibit a change in electrical resistance based on a change in applied force. The quantum tunnelling composite material may be supplied as a printable ink as indicated or alternatively in the form of a film.

In use, conductive layers 302 and 303 can be placed in close contact with pressure sensing layer 304 without activation. However, on application of a force, indicated schematically by arrow 305, conductive layers 302 and 303 are brought into contact with pressure sensing layer 304 such that an applied voltage results in a conductive path through the layers. As the applied force changes, the quantum tunnelling composite material's resistance changes, and processing the resistance allows for a magnitude of force applied to be determined.

In addition, the conductive layers 302 and 303 can be printed in the form of a sensing array, which can further be utilized to provide a measurement of position of applied force across the array in a conventional manner.

In this way, the touch sensitive elements of the analogue buttons and/or touch screen of the cover provide further flexibility in regard to the input and response. This can advantageously provide a more useful output in gaming applications.

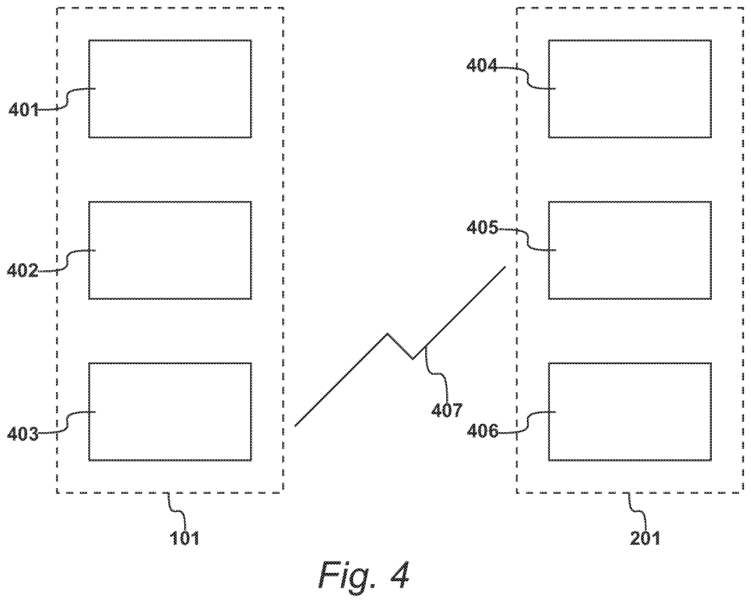

### FIG. 4

In use, cover 201 is configured to communicate with electronic device 101 as illustrated in the block diagram of FIG. 4.

In the embodiment, electronic device 101 such as a conventional smartphone or similar, comprises a processor 401 which is configured to run application software, which may include games software of any genre. It is appreciated that processor 401 is further configured to provide any necessary operation to electronic device 101 in a substantially conventional manner, which may include operating further application software beyond gaming software, such as telephonic software, email software or other types of software typically included on electronic devices of this type.

Electronic device 101 further comprises a power source 402 which is configured to provide power to electronic device 101. Typically, the power source comprises a battery, which may or may not be removable from the device. In an embodiment, the battery is an inbuilt rechargeable battery, however it is appreciated that alternative power sources may be provided.

Electronic device 101 further comprises a wireless module 403 which is configured to transmit and receive wireless signals to and from cover 201.

Cover 201 comprises a touch sensitive device 404, which may comprise a force sensitive touch sensor which is configured to measure a position of an applied force and the magnitude of the applied force. Cover 201 further comprises processor 405 which enables calculation of the position and magnitude of an applied force, in line with that as described in FIG. 3.

Cover 201 further comprises a second wireless module 406 which is configured to transmit and receive signals to and from electronic device 101.

In the embodiment, cover 201 of the present invention is connected to electronic device 101 physically in a mechanical sense. However, electrical connection 407 is made between cover 201 and electronic device 101 wirelessly by means of wireless modules 403 and 406. This enables the detachability of cover 201 from electronic device 101 as necessary, which allows greater flexibility in the gaming experience for a user.

To reduce complexity and weight, and improve packaging, cover 201 does not typically include its own power source. In the embodiment, power source 402 of electronic device 101 comprises a reverse wireless charger which is utilized to power cover 201 and its touch sensitive device(s). This advantageously avoids the need to charge cover 201 separately and means that the cover can be charged easily when further electronic supply outlets are unavailable.

In an embodiment, wireless modules 403 and 406 support the wireless technology standard marketed as Bluetooth® such that electronic device 101 and cover 201 are configured to communicate with each other via a wireless connection 407.

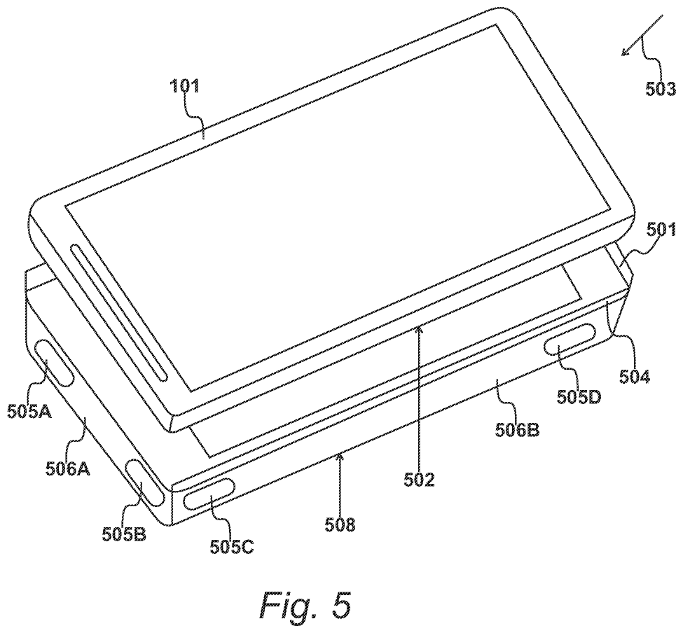

### FIG. 5

A first embodiment of a cover in accordance with the present invention in an exploded view with an electronic device is shown in FIG. 5.

Cover 501 is substantially similar to cover 201 as previously described and may include any of the features previously identified and any variations.

In the embodiment, cover 501 is configured to attach to a rear surface panel 502 of electronic device 101. In the embodiment, cover 501 fits across rear surface panel 502 to enable additional functionality to a user to the rear surface of electronic device 101.

Cover 501 is configured to slide under rear surface panel 501 and slide into place in the direction of arrow 503 by means of attachment mechanism 504. Attachment mechanism 504 comprises a clipping mechanism which allows electronic device 101 to slide onto cover 501 and clip or snap into place.

In the embodiment, cover 501 comprises a plurality of analogue input device 505 in the form of analogue buttons. In the embodiment, cover 501 comprises eight analogue buttons 505, of which two are positioned on each edge surface 506 of cover 501 as shown. It is appreciated that while only four of these analogue buttons are visible in FIG. 5, substantially similar analogue buttons are positioned on the two obscured edge surfaces in the Figure. In an embodiment, the analogue buttons 505 comprise a touch sensitive device as described in FIG. 3. In this way, force sensitivity is available to a user in operation on the side of the cover.

In the embodiment, cover 501 further comprises a touch sensitive device 507 in the form of a force sensitive trackpad. A substantially similar touch sensitive device is further positioned on the bottom surface 508 of cover 501 in a substantially similar manner to enable a user to operate cover 501 from the bottom surface.

When cover 501 is connected to electronic device 101, the solution provides a fusion of a conventional smartphone with the features of a portable gaming console, which advantageously allows for a single electronic device to function as a typical smartphone for calls, texts, emails, and other communication methods, while also functioning as a portable gaming device.

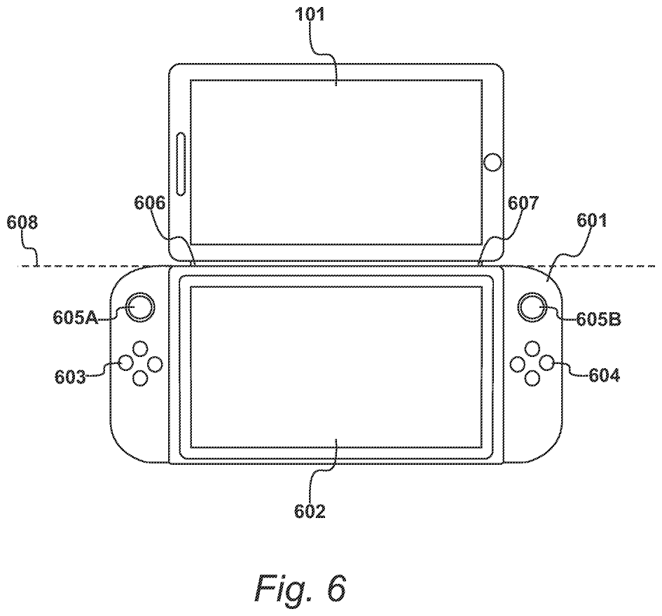

### FIG. 6

An alternative embodiment of a portable gaming device in accordance with the present invention is shown in FIG. 6. In this embodiment, cover 601 comprises a flip-type cover which is configured to be attachable and detachable to electronic device 101.

In the embodiment, cover 601 comprises at least one input device. In the embodiment, cover 601 comprises an input device comprising a touch screen 602. Cover 601 further comprises a plurality of input devices 603 and 604 in the form of a plurality of analogue buttons. It is appreciated that any number of analogue buttons may be provided on cover 601 and may be arranged in any suitable arrangement or format. In this embodiment, the plurality of input devices 603 and 604 are substantially similar to those previously described in FIG. 2 and are arranged in a substantially similar manner.

In the embodiment, the input device comprises a touch sensitive device. In the embodiment, the touch sensitive device forms part of touch screen 602. In the embodiment, each of the plurality of analogue buttons may further be provided with a touch sensitive device.

In the embodiment, input device further comprises two joysticks 605 which are further available to provide inputs by a user. It is appreciated that any combination of input devices may be utilized in accordance with the invention as required in the specific application in question, and the examples illustrated are examples only.

In the embodiment, cover 601 is attachable and detachable to a side surface 606 of electronic device 101. To facilitate this, cover 601 comprises an attachment mechanism 607 in the form of a hinge. In the embodiment, attachment mechanism 607 may be adjustable so as to enable cover 601 to be locked in place at a specific angle.

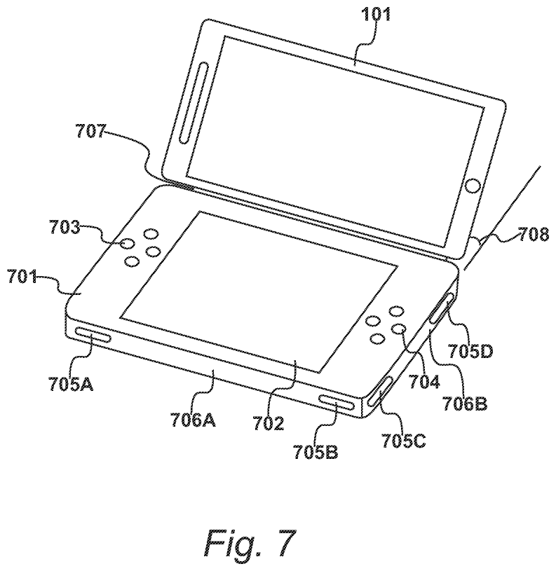

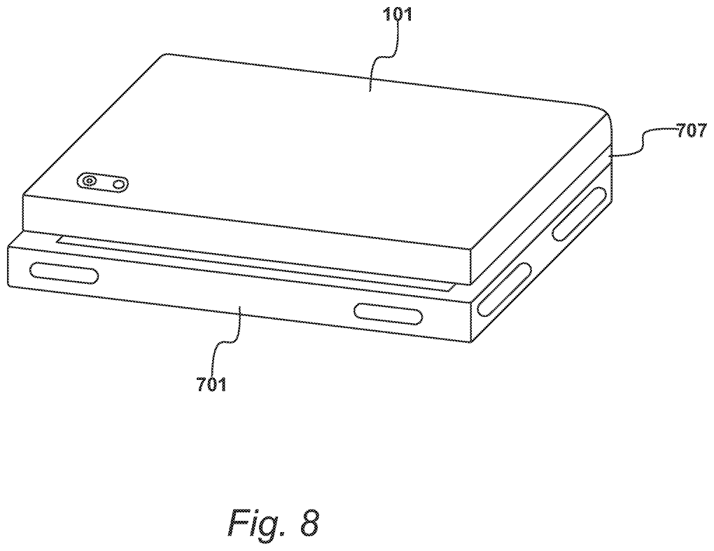

Attachment mechanism 607 allows cover 601 to hinge around an axis of rotation 608 along side surface 606. This aspect will be illustrated further with respect to FIGS. 7 and 8.

The touch sensitive device of touch screen 602 provides a dual screen capacity to the portable gaming device when the cover 601 is attached to electronic device 101. Due to the detachable nature of the cover, the additional screen can be attached and removed as required. In the embodiment, the touch screen comprises a display incorporated into the cover 601 which can display information from the application software. In conventional systems, a problem with attachable displays is that they typically function only as a display of information, rather than an interactive display with touch sensitive capacity. This consequently improves the gaming experience of a user.

### FIG. 7

An alternative embodiment of a cover 701 is shown in FIG. 7 in perspective view. Cover 701 comprises a substantially similar attachment mechanism to the embodiment of cover 601 in FIG. 6. It is appreciated that, while some differences exist in the embodiments of cover 601 and cover 701, the general concept of each of the covers in this case is substantially similar, particularly in relation to the attachment mechanism.

Thus, FIG. 7 shows a portable gaming device in accordance with the present invention comprising electronic device 101 and cover 701. In the embodiment, cover 701 comprises a flip-type cover which is configured to be attachable and detachable to electronic device 101 as shown and which is configured to be able cover both the front and rear of electronic device 101.

In the embodiment, cover 701 comprises at least one input device. In the embodiment, cover 701 comprises an input device comprising a touch screen 702. Cover 701 further comprises a plurality of input devices 703 and 704 in the form of a plurality of analogue buttons. Cover 701 further comprises a plurality of analogue buttons 705 of which two analogue buttons are positioned on each side surface 706 of cover 701. In the embodiment, touch screen 702 comprises a touch sensitive device and each of the analogue buttons also comprise a touch sensitive device to increase functionality of the buttons.

In the embodiment, cover 701 further comprises an attachment mechanism 707 which comprises a hinge which allows cover 701 to hinge around an axis of rotation along the side surface of electronic device 101 as described previously. In the embodiment, the hinge of attachment mechanism 707 is adjustable and configured to lock cover 701 in place at a predetermined angle, such as angle 708. In this illustrated embodiment, therefore, cover 701 and electronic device 101 are arranged in a manner to such that the display of electronic device 101 is easily visible and the buttons and touch screen or touch pad of cover 701 are easily accessible to operate in a gaming example. The arrangement is comparable to conventional electronic notebook arrangements.

### FIG. 8

In addition to the arrangement as shown in FIG. 7, cover 701 and electronic device 101 can rotate relative to each other and be brought together such that cover 701, when not required to function as an input device in a portable gaming device, acts to protect electronic device 101, and specifically its touch screen in the manner as illustrated in FIG. 8.

Thus, in this arrangement, the flip-cover 701 is in a closed configuration with electronic device 101 and remains attached to electronic device 101. Thus, for storage purposes, a user can rotate the devices along the axis of rotation and about hinge 707 to arrive at the closed configuration.

In this way, cover 701 can be left with electronic device 101 when not in use if required by a user. Thus, cover 701 provides dual functionality of a cover and an input device or controller that can be utilized for gaming purposes.

The invention claimed is:

1. A portable gaming device, comprising:
an electronic device comprising a processor configured to run application software; and
a cover configured to be storeable in combination with said electronic device, said cover being attachable and detachable from said electronic device, wherein:
said cover comprises an input device comprising a touch sensitive device configured to measure a position and magnitude of an applied force, and
said touch sensitive device is further configured to provide an input signal to said application software in response to said applied force.

2. A portable gaming device according to claim 1, wherein said cover is attachable and detachable to a rear surface of said electronic device.

3. A portable gaming device according to claim 1, wherein said cover is attachable and detachable to a side surface of said electronic device and configured to hinge around an axis of rotation along said side surface.

4. A portable gaming device according to claim 1, wherein said cover is powered by a power source supplied by said electronic device.

5. A portable gaming device according to claim 4, wherein said power source comprises a reverse wireless charger.

6. A portable gaming device according to claim 1, wherein said input device further comprises at least one analogue button.

7. A portable gaming device according to claim 1, wherein said input device comprises a touch screen.

8. A portable gaming device according to claim 1, wherein said cover comprises a display.

9. A portable gaming device according to claim 1, wherein said touch sensitive device comprises a force sensitive touch sensor.

10. A portable gaming device according to claim 9, wherein said force sensitive touch sensor comprises a quantum tunnelling material.

11. A portable gaming device according to claim 1, wherein said cover comprises an attachment mechanism for attaching said cover to said electronic device.

12. A portable gaming device according to claim 11, wherein said attachment mechanism comprises a clipping mechanism configured to clip said cover onto said electronic device.

13. A portable gaming device according to claim 1, wherein said cover further comprises an adjustable hinge configured to lock said cover in place at a predetermined angle.

14. A portable gaming device according to claim 1, wherein said electronic device comprises any one of the following:
a mobile telephone; a smartphone; a handheld personal computer; or a tablet computer.

15. A cover for use in gaming with an electronic device, said cover being storeable in combination with said electronic device and attachable and detachable to said electronic device, said cover comprising:
an input device comprising a touch sensitive device configured to measure a position and magnitude of an applied force, wherein:
said touch sensitive device is further configured to provide an input signal to application software of said electronic device in response to said applied force.
